(19) United States
(12) Patent Application Publication
(10) Pub. No.: US 2026/0043939 A1
(43) Pub. Date: Feb. 12, 2026

(54) METHOD FOR EVALUATING TERRAIN UNCERTAINTY IN FLOOD WARNING AND FORECASTING

(71) Applicant: Jiangsu Second Normal University, Nanjing (CN)

(72) Inventors: Yun Xing, Nanjing (CN); Tong Jiang, Nanjing (CN); Buda Su, Nanjing (CN); Qigen Lin, Nanjing (CN); Han Jiang, Nanjing (CN); Jinlong Huang, Nanjing (CN); Cheng Jing, Nanjing (CN); Xikun Wei, Nanjing (CN); Jian Zhou, Nanjing (CN)

(21) Appl. No.: 19/274,674

(22) Filed: Jul. 21, 2025

(30) Foreign Application Priority Data
Aug. 6, 2024 (CN) 202411068280.X

(51) Int. Cl. G01W 1/10; G01W 1/14; G06T 17/05

(52) U.S. Cl. CPC G01W 1/10; G01W 1/14; G06T 17/05

(57) ABSTRACT

A method for evaluating terrain uncertainty in flood warning and forecasting is provided. The method includes: S1, acquiring three types of digital elevation model (DEM) data from a shuttle radar topography mission (SRTM), an advanced spaceborne thermal emission and reflection radiometer (ASTER), and an advanced land observing satellite (ALOS); and preprocessing the three types of DEM data; S2, optimizing urban terrain characteristics; S3, constructing a multidimensional parameter space by using Latin hypercube sampling (LHS); S4, calculating flood hydrodynamics numerical value based on multidimensional sample points; and S5, constructing a global sensitivity analysis method frame suitable for urban terrain characteristics-related factors, where a Sobol quantitative method is used in the global sensitivity analysis method frame, and the Sobol quantitative method is used to evaluate uncertainties and sensitivity characteristics of multiple factors of terrain data based on a variance decomposition theory.

### CROSS-REFERENCE TO RELATED APPLICATION

This application claims the priority of Chinese Patent Application No. CN202411068280.X, filed Aug. 6, 2024, which is herein incorporated by reference in its entirety.

### TECHNICAL FIELD

The present disclosure relates to the technical field of water conservancy engineering, and particularly to a method for evaluating terrain uncertainty in flood warning and forecasting.

### BACKGROUND

Currently, urban flood numerical modeling studies both domestically and internationally widely recognize that a complex urban terrain condition is a key factor influencing flood numerical simulation results. A digital elevation model (DEM) serves as a digital expression of a terrain surface morphology required for a hydrodynamic flood numerical model. With respect to uncertainties of various degrees of multiple factors such as terrain surface characteristics, data sources, grid resolutions, and interpolation methods during a construction process of the DEM, most studies have mainly considered two aspects, i.e., different data sources and different data grid resolutions. In urban flood simulations, the use of terrain data from different data sources may lead to significant differences in simulation results (such as an inundation extent and an inundation depth). In simulation research, it is necessary to select appropriate terrain data sources according to actual needs and a scale of a simulation area. On the other hand, the grid resolutions have different degrees of impact on different simulation results (such as an inundation extent and an inundation depth). It has been found that although the grid resolutions have limited impact on an overall inundation extent of flooding, uncertainty characteristics of the grid resolutions have a strong interaction with other parameters in the hydrodynamic flood numerical model, thereby affecting sensitivities of these other parameters. Therefore, whether other terrain-related factors have similar characteristics needs further in-depth study.

### SUMMARY

The present disclosure aims to provide a method for evaluating terrain uncertainty in flood warning and forecasting. By quantifying uncertainties of terrain-related factors, an optimization solution of terrain data applied to an urban flood warning and forecasting system is provided to realize more effective urban flood warning and forecasting. Starting from the uncertainties of terrain-related factors, scientific understanding of interaction between a flood evolution process and urban terrain characteristics is improved.

In an embodiment, a method for evaluating terrain uncertainty in flood warning and forecasting is provided, which includes steps S1, S2, S3, S4, and S5.

In step S1, three types of digital elevation model (DEM) data are acquired from a shuttle radar topography mission (SRTM), an advanced spaceborne thermal emission and reflection radiometer (ASTER), and an advanced land observing satellite (ALOS), and the three types of DEM data are preprocessed.

In step S2, urban terrain characteristics are optimized.

In step S3, Latin hypercube sampling (LHS) is performed to construct a multidimensional parameter space.

In step S4, flood hydrodynamics numerical values are calculated based on multidimensional sample points.

In step S5, a global sensitivity analysis method frame suitable for urban terrain characteristics-related factors is constructed. A Sobol quantitative method is used in the global sensitivity analysis method frame. The Sobol quantitative method is used to evaluate uncertainties and sensitivity characteristics of multiple factors of terrain data based on a variance decomposition theory.

In an embodiment, the step S1 includes: determining target resolutions of the three types of DEM data and performing resampling on the three types of DEM data to obtain three types of resampled DEM data; performing quality control on the three types of resampled DEM data based on ground-measured data, determining whether the three types of resampled DEM data are distorted or has other errors, and quantifying accuracies of the three types of resampled DEM data. An algorithm for the resampling includes a nearest neighbor interpolation algorithm, a bilinear interpolation algorithm, and a cubic convolution algorithm.

In an embodiment, the step S2 includes: dividing urban terrain into three parts: road areas, river areas, and urban buildings that obstruct water flow; and performing an optimization process on the urban terrain characteristics of the three parts based on the three types of resampled DEM data obtained in the step S1, respectively.

In an embodiment, the optimization process includes: performing connectivity processing on water flow in the road areas and the river areas; and performing terrain raising on the urban buildings according to vector data of outlines of the urban buildings to process the urban buildings.

In an embodiment, the step S3 includes: determining a simulation range and distribution of each of parameters, dividing the simulation range of each parameter into intervals equal to a quantity of samples for each parameter, and randomly selecting a value in each of the intervals to ensure that each interval only appears once in the samples for each parameter, and to thereby generate sample points for each parameter, and combining sampling values of each parameter into multidimensional sample points.

In an embodiment, the step S4 includes: using the multidimensional sample points obtained in the step S3 as basic terrain data; and performing simulation calculation of the flood hydrodynamics numerical values according to rainfall scenarios of different return periods and using a flood hydrodynamic numerical model. The different return periods include 50 years, 100 years, and 200 years. The flood hydrodynamic numerical model is obtained based on a two-dimensional shallow water equation. The two-dimensional shallow water equation is expressed as follows:

$$\frac{\partial q}{\partial t} + \frac{\partial f}{\partial x} + \frac{\partial g}{\partial y} = R + {S}_{b} + {S}_{f}$$

where q contains multiple hydraulic variables; f and g represent flux vectors in an x direction and a y direction respectively; t represents a time variable, x and y represent a horizontal coordinate and a vertical coordinate respectively; and R, S_{b}, S_{f} represent source term vectors, which respectively represent a mass term, a bed slope term, and a friction term. q, f, g, R, S_{b}, and S_{f} are defined as follows:

$$q = {[ h , uh , vh ]}^{T} , f = {[ uh , {u}^{2} h + \frac{1}{2} g {h}^{2} , uvh ]}^{T} , g = {[ vh , uvh , {v}^{2} h + \frac{1}{2} g {h}^{2} ]}^{T} , R = {[ R , 0 , 0 ]}^{T} , {S}_{b} = {[ 0 , - gh \frac{\partial {z}_{b}}{\partial x} , - gh \frac{\partial {z}_{b}}{\partial y} ]}^{T} , {S}_{f} = {[ 0 , - \frac{{τ}_{b x}}{ρ} , - \frac{{τ}_{b y}}{ρ} ]}^{T}$$

where h represents a water depth; u and v represent average velocity components in the x direction and the y direction respectively; g represents an acceleration of gravity; R represents an external runoff; z_{b} represents surface elevation; ρ represents a fluid density; T represents a transpose operation; and τ_{bx} and τ_{by} represent frictional resistances in the x direction and the y direction respectively.

The simulation calculation of the flood hydrodynamics numerical values is performed according to the rainfall scenarios of the different return periods and using the flood hydrodynamic numerical model to obtain a flood evolution process, and the flood evolution process includes: a peak water level, a maximum inundation extent, and changes in a water level and an inundation area over time.

In an embodiment, in step S5, a global sensitivity analysis method suitable for urban terrain characteristics-related factors is constructed. The global sensitivity analysis method is a Sobol quantitative method. The Sobol quantitative method is used to evaluate uncertainties and sensitivity characteristics of multiple factors of terrain data based on a variance decomposition theory. Specifically, the step S5 includes: taking the peak water level and the maximum inundation extent obtained in the step S4 as output parameters of a response function, and taking the multidimensional sample points obtained in the step S3 as input variables to calculate first-order global sensitivity indices, which consist of a main index Sᵢ and a total index S_{Ti}, identifying important uncertain elements through the main index Sᵢ; identifying uncertain elements with a weak effect of the input variables on an output variance through the total index S_{Ti}. Formulas for the main index Sᵢ and the total index S_{Ti} are as follows.

An input-output relationship of the flood hydrodynamic numerical model is represented by a function Y=g(X), which is the response function of the calculation model; X=(X₁, X₂, . . . , Xₙ) represents n-dimensional random input variables; and Y represents an output variable of the flood hydrodynamic numerical model. two indicators of interest in global sensitivity analysis are selected by taking variances on both sides of the response function of the calculation model, and the two indicators are the main index Sᵢ and the total index S_{Ti}, which are expressed as follows:

$${S}_{i} = 1 - E ( V ( Y \vert {X}_{i} ) ) / V ( Y )$$

$${S}_{T i} = 1 - \frac{V ( E ( Y \vert {X}_{- i} ) )}{V ( Y )} = \frac{E ( V ( Y \vert {X}_{- i} ) )}{V ( Y )}$$

where E(V(Y|Xᵢ)) represents an average remaining amount of the output variance when a random input variable Xᵢ of the n-dimensional random input variables remains unchanged in a distribution interval of the random input variable Xᵢ; X₋ᵢ represents all random input variables except the random input variable Xᵢ; E(V(Y|X₋ᵢ)) represents an average remaining amount of the output variance when the random input variables X₋ᵢ are fixed at points in distribution intervals of the random input variables X₋ᵢ; the main index Sᵢ is used to measure an influence of the random input variable Xᵢ on the output variable of the flood hydrodynamic numerical model in an isolated state regardless of interaction of the random input variable Xᵢ with other random input variables of the n-dimensional random input variables; and the total index S_{Ti} is used to evaluate an influence of the random input variable Xᵢ on the output variable of the flood hydrodynamic numerical model when considering the interaction of the random input variable Xᵢ with the other random input variables. Further, in the above formulas, V represents a variance, and E represents an expectation, definitions of which are well known in the art.

In an embodiment, the method further includes: superimposing the main index Sᵢ and the total index S_{Ti} on a flood warning and forecasting map for displaying on a mobile phone of a user to realize flood warning and forecasting.

In an embodiment, the method further includes: based on the main index Sᵢ and the total index S_{Ti}, generating early warning and forecasting information, and broadcasting, by a broadcast system, the early warning and forecasting information to remind relevant personnel to avoid being affected by flood disasters. Further, a specific structure of the broadcast system is not limited, as long as a broadcasting function is achieved.

Compared with the prior art, the present disclosure has the following significant advantages: through quantitative analysis of uncertainty, the influence of different urban terrain data on flood hydrodynamic simulation is clarified, and the reference of terrain data suitable for numerical simulation of flood hydrodynamic in urban areas is provided, to improve the accuracy and reliability of urban flood simulation.

### BRIEF DESCRIPTION OF DRAWINGS

FIG. 1 illustrates division of urban terrain (i.e., urban area) into blocks based on characteristics of a flood evolution process according to the present disclosure.

FIG. 2 illustrates a processing procedure for terrain optimization according to the present disclosure.

FIG. 3 illustrates combination of terrain-related parameters according to the present disclosure.

FIG. 4 illustrates hydrodynamic numerical simulation results of flood inundation according to the present disclosure.

FIG. 5 illustrates impact of terrain parameters on an inundation depth assessed by a global sensitivity method according to the present disclosure.

### DETAILED DESCRIPTION OF EMBODIMENTS

Technical solutions of the present disclosure will be further explained with the accompanying drawings.

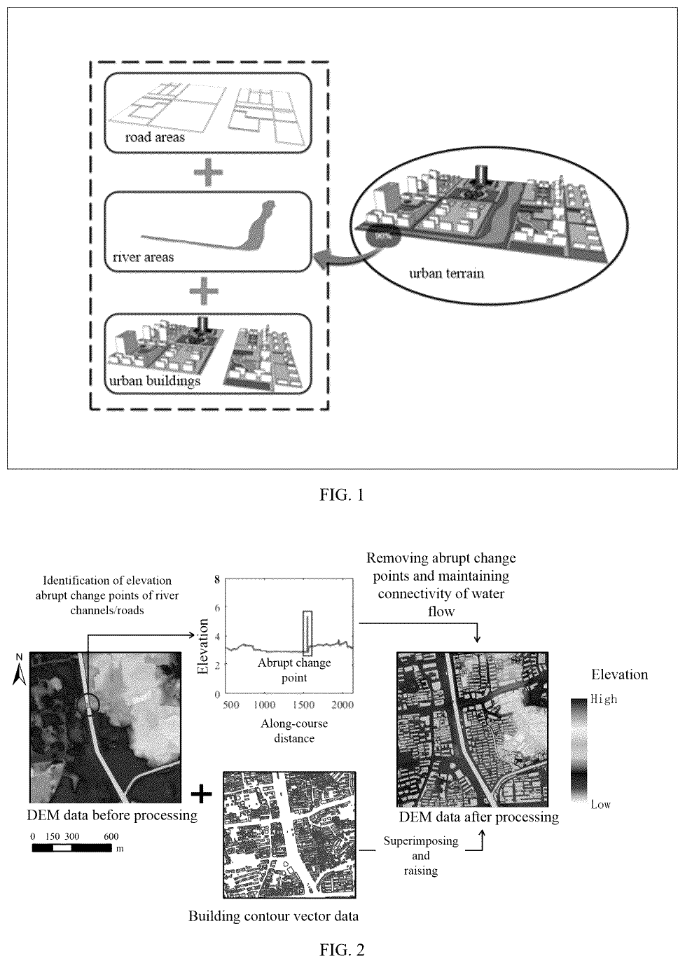

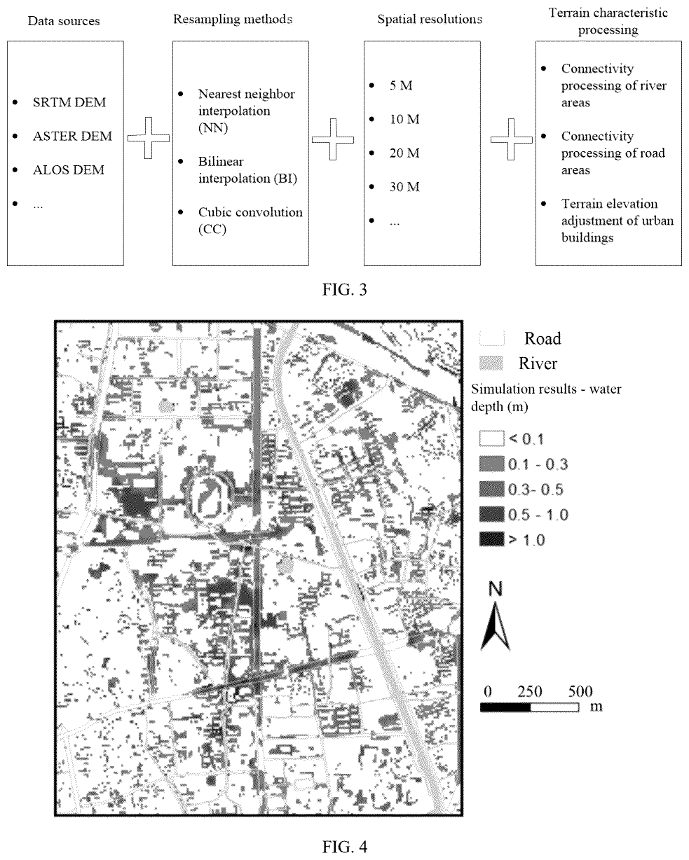

As shown in FIG. 1-FIG. 5, an embodiment of the present disclosure provides a method for evaluating terrain uncertainty in flood warning and forecasting, which includes steps S1, S2, S3, S4, and S5.

In step S1, three types of digital elevation model (DEM) data are acquired from a shuttle radar topography mission (SRTM), an advanced spaceborne thermal emission and reflection radiometer (ASTER), and an advanced land observing satellite (ALOS), and the three types of DEM data are preprocessed. Specifically, the step S1 includes: determining target resolutions of the three types of DEM data and performing resampling on the three types of DEM data to obtain three types of resampled DEM data; performing quality control on the three types of resampled DEM data based on ground-measured data, determining whether the three types of resampled DEM data are distorted or has other errors, and quantifying accuracies of the three types of resampled DEM data. An algorithm for the resampling includes a nearest neighbor interpolation algorithm, a bilinear interpolation algorithm, and a cubic convolution algorithm.

In step S2, urban terrain characteristics are optimized. Specifically, the step S2 includes: dividing urban terrain into three parts: road areas, river areas, and urban buildings that obstruct water flow; and performing an optimization process on the urban terrain characteristics of the three parts based on the three types of resampled DEM data obtained in the step S1, respectively. Specifically, the optimization process includes: performing connectivity processing on water flow in the road areas and the river areas; and performing terrain raising on the urban buildings according to vector data of outlines of the urban buildings to process the urban buildings.

In step S3, Latin hypercube sampling (LHS) is performed to construct a multidimensional parameter space. Specifically, the step S3 includes: determining a simulation range and distribution of each of parameters, dividing the simulation range of each parameter into intervals equal to a quantity of samples for each parameter, and randomly selecting a value in each of the intervals to ensure that each interval only appears once in the samples for each parameter, and to thereby generate sample points for each parameter, and combining sampling values of each parameter into multidimensional sample points.

In step S4, flood hydrodynamics numerical values are calculated based on the multidimensional sample points. Specifically, the step S4 includes: using the multidimensional sample points obtained in the step S3 as basic terrain data; and performing simulation calculation according to rainfall scenarios of different return periods and using a flood hydrodynamic numerical model. The different return periods include 50 years, 100 years, and 200 years. The flood hydrodynamic numerical model is obtained based on a two-dimensional shallow water equation. The two-dimensional shallow water equation is expressed as follows:

$$\frac{\partial q}{\partial t} + \frac{\partial f}{\partial x} + \frac{\partial g}{\partial y} = R + {S}_{b} + {S}_{f}$$

where q contains multiple hydraulic variables; f and g represent flux vectors in an x direction and a y direction, respectively; t represents a time variable, x and y represent a horizontal coordinate and a vertical coordinate, respectively; and R, S_{b}, S_{f} represent source term vectors, which respectively represent a mass term, a bed slope term, and a friction term. q, f, g, R, S_{b}, and S_{f} are defined as follows:

$$q = {[ h , uh , vh ]}^{T} , f = {[ uh , {u}^{2} h + \frac{1}{2} g {h}^{2} , uvh ]}^{T} , g = {[ vh , uvh , {v}^{2} h + \frac{1}{2} g {h}^{2} ]}^{T} , R = {[ R , 0 , 0 ]}^{T} , {S}_{b} = {[ 0 , - gh \frac{\partial {z}_{b}}{\partial x} , - gh \frac{\partial {z}_{b}}{\partial y} ]}^{T} , {S}_{f} = {[ 0 , - \frac{{τ}_{b x}}{ρ} , - \frac{{τ}_{b y}}{ρ} ]}^{T}$$

where h represents a water depth; u and v represent average velocity components in the x direction and the y direction respectively; g represents an acceleration of gravity; R represents an external runoff; z_{b} represents surface elevation; ρ represents a fluid density; T represents a transpose operation; and τ_{bx} and τ_{by} represent frictional resistances in the x direction and the y direction respectively.

The simulation calculation is performed according to the rainfall scenarios of the different return periods and using the flood hydrodynamic numerical model to obtain a flood evolution process, and the flood evolution process includes: a peak water level, a maximum inundation extent, and changes in a water level and an inundation area over time.

In step S5, a global sensitivity analysis method suitable for urban terrain characteristics-related factors is constructed. The global sensitivity analysis method is a Sobol quantitative method. The Sobol quantitative method is used to evaluate uncertainties and sensitivity characteristics of multiple factors of terrain data based on a variance decomposition theory. Specifically, the step S5 includes: taking the peak water level and the maximum inundation extent obtained in the step S4 as output parameters of a response function, taking the multidimensional sample points obtained in the step S3 as input variables to calculate first-order global sensitivity indices, which consist of a main index Sᵢ and a total index S_{Ti}; identifying important uncertain elements through the main index Sᵢ; and identifying uncertain elements with a weak effect of the input variables on an output variance through the total index S_{Ti}. Formulas for the main index Sᵢ and the total index S_{Ti} are as follows.

An input-output relationship of a calculation model is represented by a function Y=g(X), which is the response function of the calculation model; X=(X₁, X₂, . . . , Xₙ) represents n-dimensional random input variables, and Y represents an output variable of a one-dimensional model. By taking variances on both sides of the response function of the calculation model, two important indicators of interest in global sensitivity analysis are selected, which are the main index Sᵢ and the total index S_{Ti}, which are expressed as follows:

$${S}_{i} = 1 - E ( V ( Y \vert {X}_{i} ) ) / V ( Y )$$

$${S}_{T i} = 1 - \frac{V ( E ( Y \vert {X}_{- i} ) )}{V ( Y )} = \frac{E ( V ( Y \vert {X}_{- i} ) )}{V ( Y )}$$

where E(V(Y|Xᵢ)) represents an average remaining amount of the output variance when a random input variable Xᵢ remains unchanged in a distribution interval of the random input variable Xᵢ; X₋ᵢ represents all random input variables except the random input variable Xᵢ; E(V(Y|X₋ᵢ)) represents an average remaining amount of the output variance when the random input variables X₋ᵢ are fixed at points in distribution intervals of the random input variables X₋ᵢ; the main index Sᵢ is used to measure an influence of the random input variable Xᵢ on a model output in an isolated state regardless of interaction of the random input variable Xᵢ with other random input variables; and the total index S_{Ti} is used to evaluate an influence of the random input variable Xᵢ on the model output when considering the interaction of the random input variable Xᵢ with the other random input variables. Further, in the above formulas, V represents a variance, and E represents an expectation, definitions of which are well known in the art.

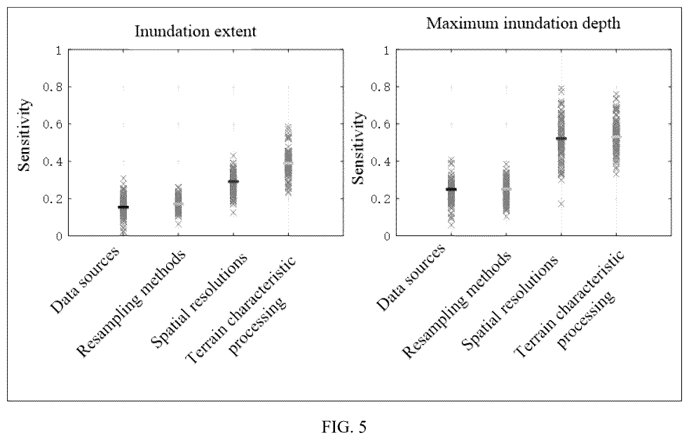

As shown in FIG. 5, results in FIG. 5 summarize influence degrees (i.e. sensitivity indices) of four factors (i.e., data sources, resampling methods, spatial resolutions, and terrain characteristic processing) on different results (the inundation extent and the maximum inundation depth) in flood numerical simulation. The data results are based on the four factors. A multidimensional parameter space is constructed by using Latin hypercube sampling (N=5,000 combinations are randomly selected from this input variation space as basic samples, and a combination of N(M+2)/2=15000 input factors is constructed, where M=4 represents a quantity of input factors). By recombining the elements in the basic samples, sensitivity indices are calculated based on a hydrodynamic numerical model and using a global sensitivity analysis method. In FIG. 5, each gray cross indicates a sensitivity metric calculated from the sampling, and a distribution of each gray cross shows good convergence compared with a sample size selected in this study. Each horizontal bars indicates an average value of a corresponding resampled sensitivity index. The results show that the spatial resolutions and the terrain feature processing have significant effects on the inundation extent and the maximum inundation depth, while the data sources and the resampling methods have little effects on the inundation extent and the maximum inundation depth.

What is claimed is:

1. A method for evaluating terrain uncertainty in flood warning and forecasting, comprising the followings steps:
S1, acquiring digital elevation model (DEM) data from a shuttle radar topography mission (SRTM), an advanced spaceborne thermal emission and reflection radiometer (ASTER), and an advanced land observing satellite (ALOS), and preprocessing the DEM data;
S2, optimizing urban terrain characteristics;
S3, performing Latin hypercube sampling (LHS) to construct a multidimensional parameter space;
S4, calculating flood hydrodynamics numerical values based on multidimensional sample points, comprising:
using the multidimensional sample points obtained in the step S3 as basic terrain data; and
performing simulation calculation of the flood hydrodynamics numerical values according to rainfall scenarios of different return periods and using a flood hydrodynamic numerical model;
wherein the different return periods comprise 50 years, 100 years, and 200 years; the flood hydrodynamic numerical model is obtained based on a two-dimensional shallow water equation; and the two-dimensional shallow water equation is expressed as follows:
$$\frac{\partial q}{\partial t} + \frac{\partial f}{\partial x} + \frac{\partial g}{\partial y} = R + {S}_{b} + {S}_{f}$$
where q contains multiple hydraulic variables; f and g represent flux vectors in an x direction and a y direction, respectively; t represents a time variable, x and y represent a horizontal coordinate and a vertical coordinate, respectively; and R, S_{b}, S_{f} represent source term vectors, which respectively represent a mass term, a bed slope term, and a friction term;
10 where q, f, g, R, S_{b}, and S_{f} are defined as follows:
$$q = {[ h , uh , vh ]}^{T} , f = {[ uh , {u}^{2} h + \frac{1}{2} g {h}^{2} , uvh ]}^{T} , g = {[ vh , uvh , {v}^{2} h + \frac{1}{2} g {h}^{2} ]}^{T} , R = {[ R , 0 , 0 ]}^{T} , {S}_{b} = {[ 0 , - gh \frac{\partial {z}_{b}}{\partial x} , - gh \frac{\partial {z}_{b}}{\partial y} ]}^{T} , {S}_{f} = {[ 0 , - \frac{{τ}_{b x}}{ρ} , - \frac{{τ}_{b y}}{ρ} ]}^{T}$$
where h represents a water depth; u and v represent average velocity components in the x direction and the y direction, respectively; g represents an acceleration of gravity; R represents an external runoff; z_{b} represents surface elevation; ρ represents a fluid density; T represents a transpose operation; and τ_{bx} and τ_{by} represent frictional resistances in the x direction and the y direction respectively;
wherein the simulation calculation of the flood hydrodynamics numerical values is performed according to the rainfall scenarios of the different return periods and using the flood hydrodynamic numerical model to obtain a flood evolution process, and the flood evolution process comprises: a peak water level, a maximum inundation extent, and changes in a water level and an inundation area over time; and
S5, constructing a global sensitivity analysis method frame suitable for urban terrain characteristics-related factors, wherein a Sobol quantitative method is used in the global sensitivity analysis method frame, and the Sobol quantitative method is used to evaluate uncertainties and sensitivity characteristics of multiple factors of terrain data based on a variance decomposition theory;
wherein the step S5 comprises: taking the peak water level and the maximum inundation extent obtained in the step S4 as output parameters of a response function, and taking the multidimensional sample points obtained in the step S3 as input variables to calculate first-order global sensitivity indices, the first-order global sensitivity indices are a main index Sᵢ and a total index S_{Ti}; identifying important uncertain elements through the main index Sᵢ; identifying uncertain elements with a target effect of the input variables on an output variance through the total index S_{Ti}; and formulas for the main index Sᵢ and the total index S_{Ti} are as follows;
wherein an input-output relationship of the flood hydrodynamic numerical model is represented by a function Y=g(X), the input-output relationship is the response function of the calculation model; X=(X₁, X₂, . . . , Xₙ) represents n-dimensional random input variables; and Y represents an output variable of the flood hydrodynamic numerical model;
wherein two indicators of interest in global sensitivity analysis are selected by taking variances on both sides of the response function of the calculation model, and the two indicators are the main index Sᵢ and the total index S_{Ti}, which are expressed as follows:
$${S}_{i} = 1 - E ( V ( Y \vert {X}_{i} ) ) / V ( Y )$$
$${S}_{T i} = 1 - \frac{V ( E ( Y \vert {X}_{- i} ) )}{V ( Y )} = \frac{E ( V ( Y \vert {X}_{- i} ) )}{V ( Y )}$$
where E(V(Y|Xᵢ)) represents an average remaining amount of the output variance when a random input variable Xᵢ of the n-dimensional random input variables remains unchanged in a distribution interval of the random input variable Xᵢ; X₋ᵢ represents all random input variables except the random input variable Xᵢ; E(V(Y|X₋ᵢ)) represents an average remaining amount of the output variance when the random input variables X₋ᵢ are fixed at points in distribution intervals of the random input variables X₋ᵢ; the main index Sᵢ is used to measure an influence of the random input variable Xᵢ on the output variable of the flood hydrodynamic numerical model in an isolated state regardless of interaction of the random input variable Xᵢ with other random input variables of the n-dimensional random input variables; and the total index S_{Ti} is used to evaluate an influence of the random input variable Xᵢ on the output variable of the flood hydrodynamic numerical model when considering the interaction of the random input variable Xᵢ with the other random input variables.

2. The method for evaluating terrain uncertainty in flood warning and forecasting as claimed in claim 1, wherein the step S1 comprises:
determining target resolutions of the DEM data and performing resampling on the DEM data to obtain resampled DEM data;
performing quality control on the resampled DEM data based on ground-measured data;
determining whether the resampled DEM data are distorted or has other errors; and
quantifying accuracies of the resampled DEM data;
wherein an algorithm for the resampling comprises a nearest neighbor interpolation algorithm, a bilinear interpolation algorithm, and a cubic convolution algorithm.

3. The method for evaluating terrain uncertainty in flood warning and forecasting as claimed in claim 1, wherein the step S2 comprises:
dividing urban terrain into three parts: road areas, river areas, and urban buildings that obstruct water flow; and
performing an optimization process on the urban terrain characteristics of the three parts based on resampled DEM data obtained in the step S1.

4. The method for evaluating terrain uncertainty in flood warning and forecasting as claimed in claim 3, wherein the optimization process comprises: performing connectivity processing on water flow in the road areas and the river areas; and
performing terrain raising on the urban buildings according to vector data of outlines of the urban buildings to process the urban buildings.

5. The method for evaluating terrain uncertainty in flood warning and forecasting as claimed in claim 1, wherein the step S3 comprises:
determining a simulation range and distribution of each of parameters;
dividing the simulation range of each parameter into intervals equal to a quantity of samples for each parameter;
randomly selecting a value in each of the intervals to ensure that each interval only appears once in the samples for each parameter, and to thereby generate sample points for each parameter; and
combining sampling values of each parameter into multidimensional sample points.
